(19) United States
(12) Patent Application Publication
(10) Pub. No.: US 2003/0038447 A1
(43) Pub. Date: Feb. 27, 2003

(54) Bycicle of periscopic traction

(76) Inventor: Aldo Cantele, Santiago (CL)

Correspondence Address: Eugenio J. Torres, Ferramas Building, Suite 1, 1060 Astiford Avenue, San Juan, PR, 00907, US

(21) Appl. No.: 10/226,561

(22) Filed: Aug. 22, 2002

(30) Foreign Application Priority Data
Aug. 22, 2001 (CL) 2071-2001

(51) Int. Cl. B62M 1/00

(52) U.S. Cl. 280/221

(57) ABSTRACT

A bicycle that allows the rider to give traction to the back wheel by extending both legs axially, that makes move periscopicly back the back part of the bicycle, uncoiling this way a cable wound in the pinenut back unirotational. After the impulse, an elastic is used to return the back part of the bicycle to the interior of the main profile and a radial spring to wind the end from the cable to its original position in the back axis This bicycle possesses a muffled front fork which serves as handle.

### STATEMENT REGARDING FEDERALLY SPONSORED RESEARCH AND DEVELOPMENT

N/A

### RELATED APPLICATIONS

This application claims the benefit of the filing date and thus foreign priority of application number 2071-2001 filed, filed Aug. 22, 2001 in Chile, the entire disclosure of which is incorporated by reference herein as if fully set forth in its entirety.

### BACKGROUND OF THE INVENTION

1. Technical Problem

Bicycles in which the rider pedals cyclically have the inconvenience that the traction is achieved with the weight of a single foot. The bicycle of this invention, by working with the force of both feet, transmits greater power each time the rider pedals.

2. State of the Art

Many types of bicycles are known in the art, there are bicycles where the rider pedals in a circular motion, while there are other bicycles where the driver pedals in a pendulum-like movement or aided by his arms, but a bicycle in which the rider pedals axially, displacing periscopically a part of the bicycle back, making the back wheel rotate as a product of the uncoiling of a cable adhered between both parts, is not known in the the art.

### OBJECT OF THE INVENTION

The object of this invention is to achieve traction by means of the separation that takes place between both parts. This movement makes the cable wound in the pinenut uncoil, which makes rotate the wheel rotate. After the impulse and thanks to an elastic or lineal spring, the back fork slips inside the main profile and a radial spring pulls the pinenut so that it tightens the cable and it makes it coil in the pinenut.

The bicycle itself, both as to its construction and its mode of operation, will be best understood, and additional objects and advantages thereof will become apparent, by the following detailed description of a preferred embodiment taken in conjunction with the accompanying drawings.

When the word “invention” is used in this specification, the word “invention” includes “inventions”, that is, the plural of “invention”. By stating “invention”, the Applicant does not in any way admit that the present application does not include more than one patentably and non-obviously distinct invention, and Applicant maintains that the present application may include more than one patentably and non-obviously distinct invention. The Applicant hereby asserts, that the disclosure of the present application may include more than one invention, and, in the event that there is more than one invention, that these inventions may be patentable and non-obvious one with respect to the other.

### BRIEF DESCRIPTION OF THE DRAWINGS

FIG. 1 is a perspective view of the bicycle of the invention;

FIG. 2 is a perspective view of the bicycle of the invention;

FIG. 3 is a front view of the bicycle of the invention in its compact position.

### DESCRIPTION OF THE PREFERRED EMBODIMENT

The bicycle as constructed in accordance with the present invention comprises a front part and a back part, there being a periscopic movement amongst said front part and said back part. The bicycle of the invention further comprises a cable between said front and said back parts, said cable being wound in the pinenut unirrotational in its back end, which is tightened by a radial spring, and in its front end, the cable is affirmed to the main profile. Inside the profile there is an elastic or lineal spring and to the side of the pinenut unirotational there is a radial spring.

To generate traction, it is necessary that the cyclist extend both legs, extracting this way the back fork of the interior of the main profile, that makes the cable that rotates the wheel uncoil. After having uncoiled the cable, it acts the elastic or lineal spring, which introduces the back fork in the main profile. Also acting the radial spring, the one that maintains tightened the pinenut with the cable.

This bicycle possesses subduing articulating the front fork and using a subject elastic between the low part of the main profile and the front fork, or using a front fork with suspension. An alternative to the disposition of the cable, it is to affirm the cable to a couple of pinenuts unirotational located to both sides of the back wheel and tightened in the low part of the main profile.

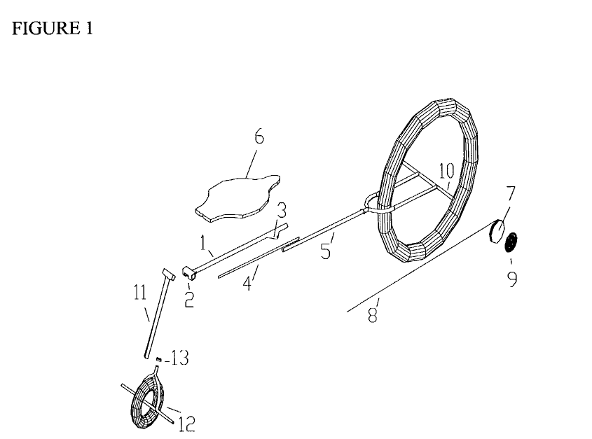

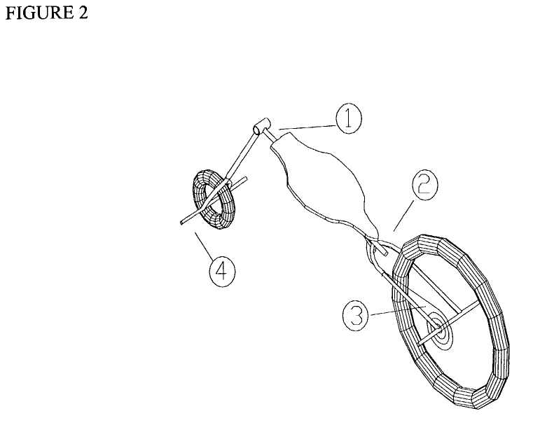

As shown in FIG. 1, the bicycle of this invention comprises a main profile (1), an articulation (2), a front support of the cable (3), an elastic (4), a back periscopic fork (5), a support for the thorax (6), a pinenut unirotational where he/she coils the cable (7), a cable (8), a radial spring that winds the cable (9), back pedals (10), a tube articulate forward (11), a front fork with its wheel (12), and a lineal spring (13).

FIG. 2 shows the articulation (1) that unites the main profile with the front fork, the back fork, which is observed in the figure, remains inside the main profile (compact position), the cable is observed affirmed in the back part of the main profile and in the other end, wound in the pinenut unirotational, it is which in turn, it is tightened for it is radial spring and, lastly, the handle can be observed

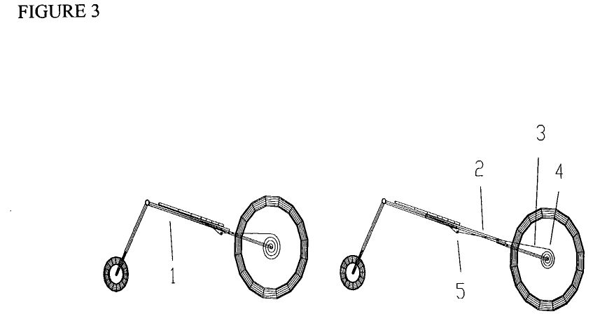

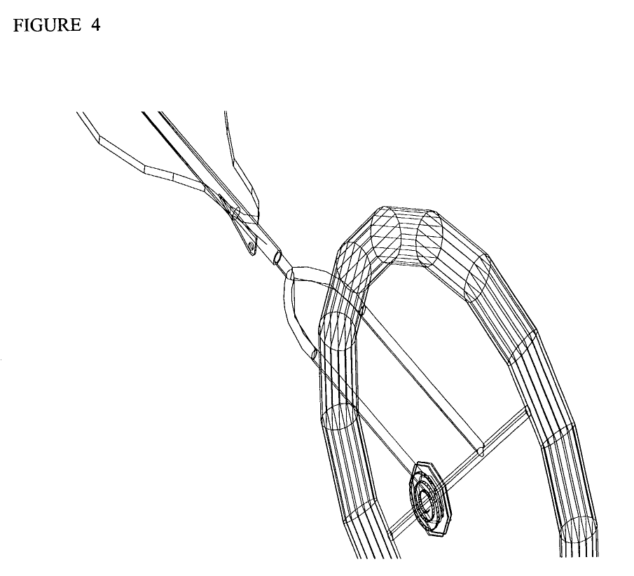

To the left of FIG. 3 the bicycle in its compact position is shown where it is observed that the elastic (1) applies a minimal tension to maintain the back fork inside of the main profile and the wound cable. The right hand drawing shows the bicycle in its extended position, after the cyclist has taken impulse from both legs the back part, extracting the back fork (2) and uncoiled the cable (3), which has make the wheel rotate, the spring being in its maximum tension, ready to wind the cable while the elastic returns to the back fork to the interior of the main profile, its initial position..

FIG. 4 shows the back fork where the pinenut unirotational and the radial spring, both installed in the back axis, can be seen.

Thus, there has been shown and described a bicycle of periscopic traction which fulfills all the objects and advantages sought therefor. The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. For example, the particular shapes and proportions of the elements of the bicycle may be varied as desired. Accordingly, all such changes, modifications, variations and other uses and applications which do not depart from the spirit and scope of the invention are deemed to be covered by this invention as defined in the following claims.

All of the patents recited herein, and in the Declaration attached hereto, if any, are hereby incorporated by reference as if set forth in their entirety herein. The details in such patents may be considered to be incorporable at applicant's option, into the claims during prosecution as further limitations in the claims to patentably distinguish any amended claims from any applied prior art.

What is claimed is:

1. A bicycle, comprising a back part and a front part, said front and back parts characterized by a periscopic movement amongst them where, the cyclist, when extending both legs, displaces back the back fork and it uncoils a cable wound in the pinenut unirotational, that makes rotate the wheel because to return the back fork, it is used an elastic or lineal spring and to maintain tightened the cable, a radial spring is used.

2. A bicycle according to claim 1, wherein the main profile possesses such a geometry that makes impossible the movement rotational between the back part of the bicycle and its front part.

3. A bicycle according to claim 1, wherein the lineal spring can work to traction settling in the front interior part of the profile the main one or he/she can work to compression, settling in the later interior part of the main profile.

4. A bicycle according to claim 1, wherein when investing the back wheel, the bicycle advances in contrary direction.

5. A bicycle according to claim 1, wherein said front part is labeled and amortized by an elastic fixed in the front fork and the main profile.

6. A bicycle according to claim 5, said front part having a suspension mechanism.
